(19) United States
(12) Patent Application Publication
(10) Pub. No.: US 2002/0057677 A1
(43) Pub. Date: May 16, 2002

(54) Method for the realization of a service for the automatic transmission of packet data, as well as communication network, information computer and program module for it

(75) Inventors: Lothar Katzschner, Stuttgart (DE); Andreas Lemke, Stuttgart (DE); Emmanuel Sutter, Bonn (DE); Wolfgang Zeller, Steinenbronn (DE)

Correspondence Address: SUGHRUE, MION, ZINN, MACPEAK & SEAS, PLLC, 2100 Pennsylvania Avenue, N.W., Washington, DC, 20037-3213, US

(73) Assignee: ALCATEL

(21) Appl. No.: 09/985,203

(22) Filed: Nov. 2, 2001

(30) Foreign Application Priority Data
Nov. 16, 2000 (DE) 100 56 823.8

(51) Int. Cl. H04L 12/56

(52) U.S. Cl. 370/352; 370/356; 370/389

(57) ABSTRACT

The invention concerns a method for the realization of a service for an automatic transmission of packet data to a subscriber of a communication network which comprises a packet data network, in particular, an Internet information service, the packet data to be transmitted being stored in a network facility of the communication network and being transmitted via the packet data network, wherein, if the communication network also comprises a circuit-switching telephone network, a telephone call of a first subscriber to a further subscriber causes the network facility to transmit packet data to one of the subscribers, as well as a communication network, an information computer and a program module for it.

### BACKGROUND OF THE INVENTION

The invention is based on a priority application DE 100 56 823.8, which is hereby incorporated by reference.

The invention concerns a method to realize a service for an automatic transmission of packet data of a communication network which comprises a packet data network, in particular, an Internet information service, the packet data to be transmitted being stored in a network facility of the communication network and being transmitted via the packet data network, as well as a communication network, an information computer and a program module for it.

In the public telephone network (PSTN), a service is available for the transmission of the call number of the calling subscriber (calling line identification presentation, CLIP). In the case of this service, which is specified in the document “ITU-T Recommendation Q.951”, this call number is transmitted in the course of the establishment of the connection to the telephone terminal of the subscriber to be called, where it can be displayed, e.g. by means of an LCD display of the telephone terminal. The called subscriber can identify the calling subscriber on the basis of the transmitted call number. In modern telephone terminals, the name of the calling subscriber can also be directly displayed on the LCD display, provided that a linkage exists between his call number and his name. This service, originally defined for the ISDN (integrated services digital network), is also available for mobile radio telecommunication subscribers and has even been available for some time for subscribers with analog network connection. Also specified in the above-mentioned standard is a service for displaying the call number of the called subscriber (connected line presentation, COLP) to the calling subscriber. This service (COLP) is not generally realized, however, since the display of the call number of the called subscriber to the calling subscriber merely makes it possible to check that the required call number corresponds to the dialled call number. Corresponding to the service for displaying the call number (CLIP), the subscribers have the possibility of blocking this service.

Internet subscribers have the possibility of setting up, or having set up, so-called home pages which are stored on particular computers or servers of the Internet. These home pages represent particular web pages which are identifiable through a unique address, the so-called uniform resource locator (URL). An Internet subscriber who wishes to receive a particular home page of another subscriber transmits into the Internet the corresponding resource locator with the Internet address of his Internet terminal, referred to below, in short form, as the IP address. The required home page is then transmitted to the said Internet terminal in the form of data packets, so-called IP datagrams, where it is displayed by means of a particular program, referred to, in short form, as a browser. Unlike the service described above for call number display, the Internet thus permits the transmission of extensive and individually arranged visual information.

The patent specification U.S. Pat. No. 5,724,412 describes facilities and a method with which, upon a telephone call by a telephone subscriber, particular address information, for example, a resource locator (URL), as mentioned above, is transmitted to the calling or the called subscriber. In this case, the transmission of the address information, like the transmission of the call number in the case of the service described above for call number transmission, is effected through signalling from the telephone network to the telephone subscriber. The telephone subscriber can then use this address information to call up corresponding information of the telephone call partner which is stored on the Internet, for example, his home page, from an Internet terminal. In the case of this method, the address information received by the telephone terminal must be entered manually on the Internet terminal unless the subscriber has available special devices which permit the transmission of the address information from the telephone terminal to the Internet terminal.

An Internet subscriber normally receives a required web page by calling up this web page, i.e., following transmission of the corresponding resource locator (URL). However, there have also been known for some time methods on the Internet, so-called push methods, in which a server transmits web pages to particular subscribers without solicitation. By means of such a method, it is possible to transmit current messages to selected subscribers, either immediately upon occurrence of these messages or at defined intervals, without the need for these subscribers to call up corresponding web pages in advance. It is on this that the invention is based.

### SUMMARY OF THE INVENTION

The object of the invention is to describe a service in which an automatic transmission of packet data is effected in conjunction with a telephone call to subscribers, without the need for additional equipment on the part of the subscriber apart from a telephone terminal and a packet data terminal which is independent of the latter. A further object of the invention is to describe appropriate means on the network side for the realization of this service.

The Internet, as a packet data network which is accessible worldwide, is the most widespread packet data network. In the consideration of packet data networks, the present description is restricted below to the Internet, without so restricting the invention. In particular, the invention can also be realized with a so-called intranet, which operates according to the same principles as the Internet but is locally restricted, e.g. to company locations of a company.

The basic concept of the invention is the linkage, on the network side, of call numbers of the telephone terminals to IP addresses of the Internet terminals of subscribers or to packet data.

In the course of a telephone call, the IP addresses of the Internet terminals of those subscribers participating in the call who are to receive particular packet data are determined on the basis of this linkage.

In a first embodiment, it is determined, in a telephone call of a calling subscriber, whether packet data of the subscriber to be called is available for transmission to the calling subscriber. If corresponding packet data is available, this packet data is transmitted to the Internet terminal of the calling subscriber.

In a further embodiment, it is determined, in a telephone call of a calling subscriber, whether packet data of the calling subscriber is available for transmission to the Internet terminal of the subscriber to be called. If corresponding packet data is available, this packet data is transmitted to the Internet terminal of the subscriber to be called.

Further advantageous developments of the invention are disclosed by the dependent claims and the description.

### BRIEF DESCRIPTION OF THE DRAWING

The invention is described below in greater detail, with reference to the drawings, wherein:

FIG. 1 shows a communication network according to the invention, consisting of the Internet and the public telephone network,

FIG. 2 shows an exemplary block diagram with the principal network facilities involved in the method according to the invention,

FIG. 3 shows exemplary facilities of the Internet for the realization of a first variant of a method according to the invention, and

FIG. 4 shows exemplary facilities of the Internet for the realization of a second variant of a method according to the invention.

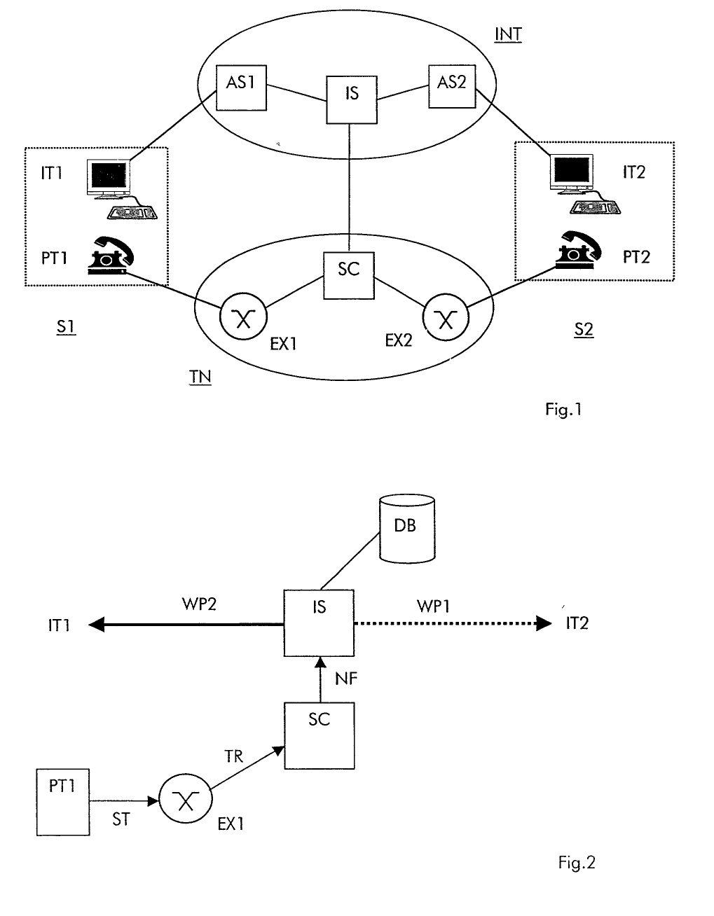

FIG. 1 shows a communication network, consisting of the Internet and the (public) telephone network TN, as well as a first (subscriber) terminal facility SI and a second (subscriber) terminal facility S2. The Internet INT comprises a first access computer AS1 and a second access computer AS2, as well as an information computer IS. The telephone network TN comprises a first switching centre EX1 and a second switching centre EX2, as well as a control computer SC. The terminal facilities S1 and S2 comprise a first Internet terminal IT1 and a second Internet terminal IT2 respectively, as well as a first telephone terminal PT1 and a second telephone terminal PT2 respectively. The telephone terminals PT1 and PT2 are connected to the switching centres EX1 and EX2 respectively. The switching centres EX1 and EX2 are each connected to the control computer SC. Communication between the telephone network TN and the Internet INT is effected via a connection between the control computer SC and the Information computer IS, which is additionally connected to each of the access computers AS1 and AS2. The access computers AS1 and AS2 are connected to the Internet terminals IT1 and IT2 respectively.

In this instance, the general case is assumed that the telephone terminals PT1 and PT2 are each connected to different switching centres EX1 and EX2 respectively and the Internet terminals IT1 and IT2 are each connected to different access computers AS1 and AS2 respectively. In special cases, both telephone terminals PT1 and PT2 can be connected to the same switching centre and/or both Internet terminals IT1 and IT2 can be connected to the same access computer.

The subscriber calling from the first telephone terminal PT1 of the first terminal facility S1 is referred to below, in abbreviated form, as the calling subscriber S1 and the subscriber to be called at the second telephone terminal of the second terminal facility S2 is referred to below, in abbreviated form, as the subscriber to be called S2. It is assumed that both subscribers S1 and S2 have set up the service, described above, for the automatic transmission of packet data, i.e., linkage of the call number of the telephone terminal PT1 or PT2 and the Internet address of the Internet terminal IT1 and IT2 respectively is known to both subscribers.

It is assumed, firstly, in this case that the Internet terminals IT1 and IT2 of the two subscribers S1 and S2 are each permanently online (connected to the Internet); i.e., they have a communication connection to the Internet INT and are thus ready to send and receive packet data at any time. The connections shown in FIG. 1 represent logical communication connections which, physically, can be routed quite differently. In particular, the connections of the various terminals of a subscriber to the telephone network TN and to the Internet, for example, the connections of the telephone terminal PT1 and of the Internet terminal IT1, which are depicted separately in FIG. 1, represent what is physically often the same line segment via which, for example, two independent communication connections can be simultaneously established by means of the known ISDN method for digital access to the public telephone network or by means of an ADSL (asynchronous digital subscriber line) method. In this present case, one of these lines is used as a telephone connection and the other connection is used as an Internet connection.

The switching centres EX1 and EX2 inform the control computer SC of each incoming call from a telephone terminal PT1 or PT2 connected to the switching centre EX1 and EX2 respectively. The control computer SC signals to the information computer IS the call numbers of the calling subscriber S1 and of the subscriber to be called S2. The information computer IS thereupon checks whether packet data of one of the said subscribers is available for transmission to the other of the said subscribers and transmits this packet data, via the access computers AS1 or AS2, to the Internet terminals IT1 or IT2 respectively of the subscribers S1 and S2 respectively.

In this case, the control computer SC serves essentially as an interface computer of the telephone network TN to the Internet, forwarding to the information computer IS the information received from the switching centres EX1 and EX2. The control computer SC additionally comprises functions for checking the completeness of the data to be transmitted to the information computer IS. Furthermore, it determines the charges charged to the subscribers S1 and/or S2 and forwards this data to a billing facility, which is not shown here.

The control computer SC can be realized as a central computer, multi-computer system or as a decentralized multi-computer system. As a decentralized multi-computer system, the individual computers can also each be directly assigned to the switching centres EX1 and EX2 or directly integrated into the switching centres EX1 and EX2. The information computer IS can also be realized as a multi-computer system. Furthermore, it is possible to combine the functions of the control computer SC and the functions of the information computer IS in a common computer or multi-computer system.

The principle of the operation of the method described with reference to FIG. 1 is described below in detail. For this purpose, FIG. 2 shows the first switching centre EX1, the control computer SC, the information computer IS, the first Internet terminal IT1, the second Internet terminal IT2 and the first telephone terminal PT1 from FIG. 1. Also represented is a databank DB connected to the information computer IS. An arrow directed from the first telephone terminal PT1 to the switching centre EX1 symbolises a SETUP signal ST, an arrow directed from the first switching centre EX1 to the control computer SC symbolises a trigger signal TR, an arrow directed from the control computer SC to the information computer IS symbolises a notification signal NF, an arrow directed from the information computer IS to the first internet terminal IT1 symbolises second packet data WP2 and an arrow represented as a broken line and directed from the information computer IS to the second Internet terminal IT2 symbolises optional first packet data WP1.

For the operation, described below, of the method according to the invention for the realization of a service for the automatic transmission of packet data, it is assumed, without restriction of universality, that the subscriber S1 is the calling subscriber and the subscriber S2 is the subscriber to be called.

The subscriber S1 dials the call number of the subscriber S2. During or following dialling, a check is performed in the switching centre EX1 to determine whether the calling subscriber S1 is a subscriber of the said service. In order to initiate the realization of the service, it is necessary for the trigger signal TR to be transmitted to the control computer SC. This transmission contains the call number of the subscriber to be called S2 and of the calling subscriber S1. The call number of the calling subscriber S1 is known to the switching centre EX1, the call number of the subscriber to be called S2 is obtained from the dialling information in the SETUP signal of the subscriber S1; if necessary, further dialling information from subsequent INFO signals is to be subsequently supplied. It is also possible for the service to be initiated following receipt of a so-called address-complete message (ACM).

The control computer SC checks the received trigger signal TR for completeness. The control computer SC then transmits the notification signal NF, containing the complete call numbers of the subscribers S1 and S2, to the information computer IS. The information computer IS determines the packet data WP2 of the subscriber to be called S2 which is contained in the databank DB and intended for the calling subscriber S1, and the IP address of the first Internet terminal IT1 of the calling subscriber S1, and then transmits the packet data WP2.

The information computer IS additionally or optionally determines the packet data WP1 of the calling subscriber S1 which is available in the databank DB and intended for the subscriber to be called S2, and the IP address of the second internet terminal IT2 of the subscriber to be called S2, and then transmits the packet data WP1.

It has been assumed hitherto that the packet data WP1 or WP2 is already durably stored in the databank DB. Alternatively, however, certain base information can be stored in the databank, from which the corresponding packet data WP1 or WP2 is generated in the information computer IS only at a given time. In this case, the information computer IS can also receive current data, for example, image sequences, of the subscribers S1 or S2, which is then transmitted as packet data WP1 or WP2, or as a constituent part of the corresponding packet data.

It is also possible for the control computer SC to be informed by a trigger signal TR not from the first switching centre EX1, to which the calling subscriber S1 is connected, but from the second switching centre EX2, to which the subscriber to be called S2 is connected. In this case it is advantageous that both call numbers, the call number of the calling subscriber S1 and the call number of the subscriber to be called S2, are always known in full to the second switching centre EX2 and, in particular, there is no need for the complete call number of the subscriber to be called S2 to be determined only in subsequent steps. A disadvantage is that, if a connection cannot be established between the switching centres EX1 and EX2, for example, in the case of overloading of respective lines, the described service cannot be realized.

In an advantageous development, it is possible to determine for the described service, either individually by each subscriber or generally, at which instant in a telephone call the transmission of the packet data WP1 and WP2 is to be effected. Thus, the transmission can be effected either during the establishment of a connection, during a connection or following a connection tear-down. For this purpose, the control computer SC is informed by the respective switching centre EX1 or EX2 of the instant of the telephone call, the instant of establishment of the connection and the instant of connection tear-down. It transmits the notification signal NF to the information computer IS either immediately at the determined instant or explicitly informs the information computer IS concerning status changes in a telephone connection.

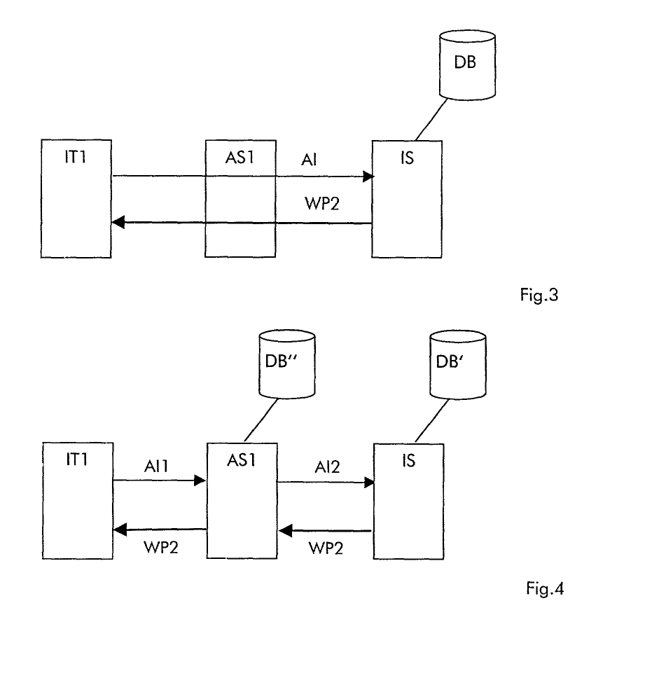

It has been assumed hitherto that the Internet terminals IT1 and IT2 of all subscribers S1 and S2 of the described services are permanently online and the IP addresses of the Internet terminals IT1 and IT2 are known in the information computer IS. Frequently, however, these Internet terminals IT1 and IT2 are online only sporadically or intermittently. Since many Internet terminals do not have a static IP address, but a newly assigned IP address for each Internet session, in order for the described service to be realized, it is necessary to know when a subscriber can be reached and under which IP address his Internet terminal can be reached. A method for this is presented with reference to each of the following drawings FIG. 3 and FIG. 4.

FIG. 3 shows, known from the preceding drawings, the first Internet terminal IT1, the first access computer AS1, the information computer IS and the databank DB, connected to the information computer IS. An arrow directed from the first Internet terminal IT1 to the information computer IS via the first access computer AS1 symbolises an address signal AI. An arrow in the opposite direction, directed from the information computer IS to the first Internet terminal IT1 via the first access computer AS1 symbolises the second packet data WP2 known from FIG. 2. When the first Internet terminal IT1 is connected online, an IP address is allocated to it with the Internet INT log-on procedure. The first Internet terminal IT1 then informs the information computer IS of this current IP address through transmission of the address signal AI. This address information is entered in the databank DB. From this instant onwards, the information computer IS can transmit the packet data WP2 intended for the subscriber S1 to the respective first Internet terminal IT1, via the first access computer AS1. The first access computer AS1 does not influence the datagrams of the second packet data WP2 routed through it; if necessary, only protocol conversion of the protocol layers below the network layer is effected.

The first Internet terminal IT1 repeats the transmission of the address signal AI for is long as it is online, between defined time intervals. The repeated transmission of the address signal AI has the function of a “life signal”; if the information computer IS does not receive any further address signal AI of an Internet terminal IT1 or IT2 for a period of time exceeding a defined time interval, it assumes this Internet terminal IT1 or IT2 to have been disconnected and erases the corresponding IP address from the databank DB.

A problem of a service with automatic data transmission is that a subscriber of such a service may receive unwanted data from unauthorized senders. In order to prevent the transmission of unwanted packet data, the access computers AS1 and AS2 also act as security servers which transmit only packet data of the services subscribed to or requested by the subscriber S1 and/or S2.

If a subscriber S1 or S2 wishes to prevent the receipt of the packet data WP2 and WP1 respectively, despite the Internet terminal IT1 or IT2 respectively being connected, the function for transmitting the address information AI is deactivated in the respective Internet terminal IT1 or IT2.

In an advantageous development of the invention, a time-selective and/or receiver-selective selection of the packet data WP2 and WP1 to be sent to a receiver S1 or S2 respectively is performed in the information computer IS. Thus, for example, different information for different times of day, or different information for different recipients or groups of recipients, can be stored in the databank DB.

In a further advantageous development, a called subscriber S2 decides only after he has identified the calling subscriber S1 which particular packet data WP2 is to be transmitted to the calling subscriber S1, or whether any packet data WP2 at all is to be transmitted to the calling subscriber S1. For this purpose, he transmits to the information computer IS, via the second Internet terminal IT2, for example, following receipt of a request to enter the selection of packet data to be transmitted, a corresponding request for the transmission of particular packet data. It is also possible for him to transmit a corresponding request, for example, through the entry of particular digits, via the second telephone terminal PT2.

A modified method is now described, with reference to FIG. 4 and by way of example, which has the advantage, compared with the method described with reference to FIG. 3, that dynamic address information AI of the internet terminal IT1 is not required in the information computer IS, due to a modified task division of the (central) information computer IS and of the access computers AS1 and AS2.

FIG. 4 shows, known from FIG. 3, the Internet terminal IT1, the first access computer AS1 which is connected to a decentralized databank DB″, as well as the information computer IS, known from FIG. 3, which is connected to a central databank DB′. An arrow directed from the information computer IS to the first access computer AS1 and an arrow directed from the latter to the first Internet terminal IT1 each symbolise the second packet data WP2 known from FIG. 3. An arrow directed from the first Internet terminal IT1 to the first access computer AS1 symbolises a first address information message AI1 and an arrow directed from the first access computer AS1 to the information computer IS symbolises a second address information message AI2.

After the first Internet terminal IT1 has received an IP address, following connection online, with the first address information message AI1 it transmits this IP address, together with the call number of its telephone terminal PT1, to the access computer AS1 and thereby activates the said services for itself. Irrespective of this, or upon each activation by a subscriber S1, the access computer AS1 informs the information computer IS, with the second address information message AI2, which subscribers are to be accessed through it.

Stored for the subscribers S1 and S2 in the central databank DB′ of the information computer IS is the IP address of the assigned access computer AS1 and AS2 respectively. When the said service is called up, irrespective of whether an addressee S1 of the packet data WP2 has a connected Internet terminal IT1, the information computer IS immediately transmits this packet data WP2 to the assigned access computer AS1. If this first Internet terminal IT1 is connected, the first access computer AS1 immediately transmits this data on to the first Internet terminal IT1. Unlike the situation described with reference to FIG. 3, direct transmission of an address information message AI from the first internet terminal IT1 to the information computer IS is no longer necessary, since the first access computer AS1 knows the current IP address of the subscriber S1 as soon as he goes online. For this, however, it must be constantly ensured that the assignment of each subscriber to a corresponding access computer is known in the central databank DB′. If the first Internet terminal IT1 is not connected , the packet data WP2 can be stored in the first access computer AS1 for a defined period of time and fetched by the Internet terminal IT1 at a given time.

In the case of a more decentralized method, the packet data WP1 and WP2 is also stored, partially or wholly, in the decentralized databanks DB″ of the access computers AS1 and AS2. In order to transmit packet data WP2 to the respective Internet terminal IT1, for example, the information computer IS fetches the packet data WP2 from the second access computer AS2 when currently required and transmits this packet data WP2 to the first access computer AS1. Upon activation by a subscriber S1, the first access computer AS1 assigned to him can optionally transmit to the (central) information computer IS and temporarily store in the central databank DB′ the packet data WP2 stored in the decentralized databank DB″, for as long as the subscriber S1 has activated the described service. This method is particularly advantageous if, firstly, large quantities of data have to be managed and, secondly, the described service has been simultaneously activated by only a small proportion of the subscribers.

In a further option, an Internet terminal IT1 or IT2 which is not connected is notified by the corresponding access computer AS1 and AS2 respectively as soon as corresponding packet data is present. This requires additional prompt signals which, in the case of an ISDN connection, for example, are transmitted to the subscribers S1 or S2 via the signalling channel. Immediately upon receipt of such a prompt signal, the Internet terminals IT1 and/or IT2 of the subscribers automatically initiate the Internet connection procedure. This prompt signal can be represented through allocation of a defined parameter in the SETUP signal which is received in any case.

1. Method to realize a service for an automatic transmission of packet data to a subscriber of a communication network which comprises a packet data network, in particular, an Internet information service, the packet data to be transmitted being stored in a network facility of the communication network and being transmitted via the packet data network, wherein, if the communication network also comprises a circuit-switching telephone network, a telephone call of a first subscriber to a further subscriber causes the network facility to transmit packet data to one of the subscribers.

2. Method according to claim 1, wherein the packet data contains information of a subscriber to be called or called subscriber which is transmitted to a calling subscriber.

3. Method according to claim 2, wherein a called subscriber determines, through communication with the network facility, whether packet data is to be transmitted to the calling subscriber or which packet data is to be transmitted to the calling subscriber.

4. Method according to claim 1, wherein the packet data contains information of a calling subscriber which is transmitted to a subscriber to be called.

5. Method according to claim 1, wherein the packet data can contain different information, depending on the instant of the call, in particular, depending on the time of day and/or the date.

6. Method according to claim 1, wherein the packet data can contain different information, depending on the telephone number of the subscriber for whom the data is intended.

7. Method according to claim 1, wherein it can be determined whether the packet data is transmitted before a telephone connection, during a telephone connection or following the tear-down of a telephone connection.

8. Method according to claim 1, wherein the network facility is currently informed, by each online packet data terminal of a subscriber, of its address to which the respective packet data is to be transmitted.

9. Method according to claim 1, wherein the network facility transmits the packet data which is to be transmitted to an Internet access computer which determines the address of a packet data terminal of the respective subscriber to which this packet data is to be transmitted.

10. Communication network, comprising of a packet data network and a circuit-switching telephone network, to realize a service for an automatic transmission of packet data to telephone subscribers, with the following facilities:
Trigger facilities for triggering a control computer upon detection of a telephone call of a telephone subscriber of the said service,
a control computer for transmitting to an information computer the call number of a calling telephone subscriber and of a telephone subscriber to be called and
an information computer for transmitting to the respective packet data terminals the stored packet data intended for the calling telephone subscriber and/or the telephone subscriber to be called.

11. Information computer for the transmission of packet data to a packet data terminal of at least one telephone subscriber participating in a telephone call, with
first receiving means for receiving the call numbers of the telephone subscribers,
assignment means for assigning particular packet data to the addresses of the packet data terminals and
transmission means for transmitting the assigned packet data to the respective packet data terminals.

12. Information computer according to claim 11, wherein there are also further receiving means for receiving an address information message, containing the IP address, of a packet data terminal.

13. Program module for execution in an information computer for the realization of a service for the automatic transmission of packet data to a packet data terminal of at least one telephone subscriber participating in a telephone call, with program means for controlling
first receiving means for receiving the call numbers of the telephone subscribers, the assignment of particular stored packet data to the IP addresses of packet data terminals which are addressees of the packet data and
transmission means for transmitting the packet data to the respective packet data terminals.
